(19) United States
(12) Patent Application Publication
(10) Pub. No.: US 2002/0174257 A1
(43) Pub. Date: Nov. 21, 2002

(54) Application assisted executable exports

(75) Inventors: Jeffrey Allen Jones, Austin, TX (US); Jeffrey S. Kobal, Cedar Park, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/848,172

(22) Filed: May 3, 2001

(51) Int. Cl. G06F 9/00

(52) U.S. Cl. 709/310; 709/320

(57) ABSTRACT

A method, system, and computer program product for resolving missing modules and/or exports during an application load routine is provided. This augments the programmatic interface to the loader (i.e. DosQueryProcAddr( )). In one embodiment, the application includes several modules. One or more of the modules include, in addition to the export or import list, a loader helper function. Whenever the loader fails to find an export or other missing module, the loader helper function may be called and given control of the module/export resolution process whenever its default behavior fails. The loader helper function may be implemented in many fashions and may provide several mechanisms including an ability to search and locate the missing module, an ability to load the missing module from a network, such as the internet, or simply allowing the user to be notified of the problem and then allowing the application to exit gracefully rather than having the application fail to load without any notice to the user.

### BACKGROUND OF THE INVENTION

1. Technical Field

The present invention relates generally to computer software and, more particularly, to an improved method for locating and loading executable exports.

2. Description of Related Art

Executable modules (DLLs and EXEs) both import and export “addresses” of functions and/or data, often referred to as “imports” and “exports” or “entry points.” There are two ways for an executable module to import entry points from another module. They can either be imported/resolved automatically on the module's behalf by the loader at loadtime or they can be imported/resolved programmatically by the module itself during runtime.

For imports to be resolved automatically by the loader, the module must be built with a fixed list of imports that the loader must correlate to another module/entry point during the loading of the module. The advantage of this is that the gory details of importing hundreds, perhaps thousands or tens of thousands, of entry points are transparently hidden from the developer. Disadvantages are that all entry points must be resolved to load the module whether they are used or not (impacting performance) and the module will fail to load if the required entry points (or their module) cannot be found. The loader cannot and does not do a very thorough or good job of finding the required modules.

Importing entry points programmatically can be a chore. It can require several lines of code per import—multiplied by tens, hundreds or perhaps many thousands of entry points. But importing entry points programmatically has many advantages. The imports (and therefore the modules they are dependent on) need only be referenced “if” they are needed, increasing performance. The importing module can make any number of attempts to search for and locate the import/module. The program can change its behavior rather than fail if an import cannot be resolved (i.e. ignoring data related to uninstalled plugins or simply not printing if the “print module” is missing). Most importantly, however, is the ability of the application or module to involve the user either by asking where the module might be found or simply reporting that there is a problem and what it might be rather than simply and mysteriously failing to load, as happens with unresolved imports hard coded into the import list.

Today, in “prior art”, there is only one way to export an entry point from a module: via a hard coded list bound into the module when it is created, the reverse of the imports list described above. Missing is any way to programmatically create or otherwise resolve exports not explicitly exported. Therefore, it would be desirable to have a system to resolve exports not explicitly exported rather than simply allowing an application load to fail without the user having any knowledge of why the application failed to load.

### SUMMARY OF THE INVENTION

The present invention provides a method, system, and computer program product for resolving missing modules and/or exports during an application load routine. This augments the programmatic interface to the loader (i.e. DosQueryProcAddr( )). In one embodiment, the application includes several modules. One or more of the modules include, in addition to the export or import list, a loader helper function. Whenever the loader fails to find an export or other missing module, the loader helper function may be called and given control of the module/export process whenever its default behavior fails. The loader helper function may be implemented in many fashions and may provide several mechanisms including an ability to search and locate the missing module, an ability to load the missing module from a network, such as the internet, or simply allowing the user to be notified of the problem and then allowing the application to exit gracefully rather than having the application fail to load without any notice to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram illustrating a data processing system in which the present invention may be implemented;

FIG. 2 depicts a block diagram illustrating a prior art system for importing modules;

FIG. 3 depicts a block diagram illustrating basic imports/exports at work according to the prior art;

FIG. 4 depicts a block diagram of a prior art method of loading an export illustrating a problem when a module is missing;

FIG. 5 depicts a block diagram illustrating a module that includes a loader helper function in accordance with the present invention;

FIG. 6 depicts a diagram illustrating an exemplary loader helper function pseudocode in accordance with the present invention;

FIG. 7 depicts a process flow and program function for use in a loader to provide a loader helper function to help locate and load modules in accordance with the present invention; and

FIG. 8 depicts a process flow and program function for import resolution using a loader helper function in accordance with the present invention.

### DETAILED DESCRIPTION OF THE PREFERRED EMBODIMENT

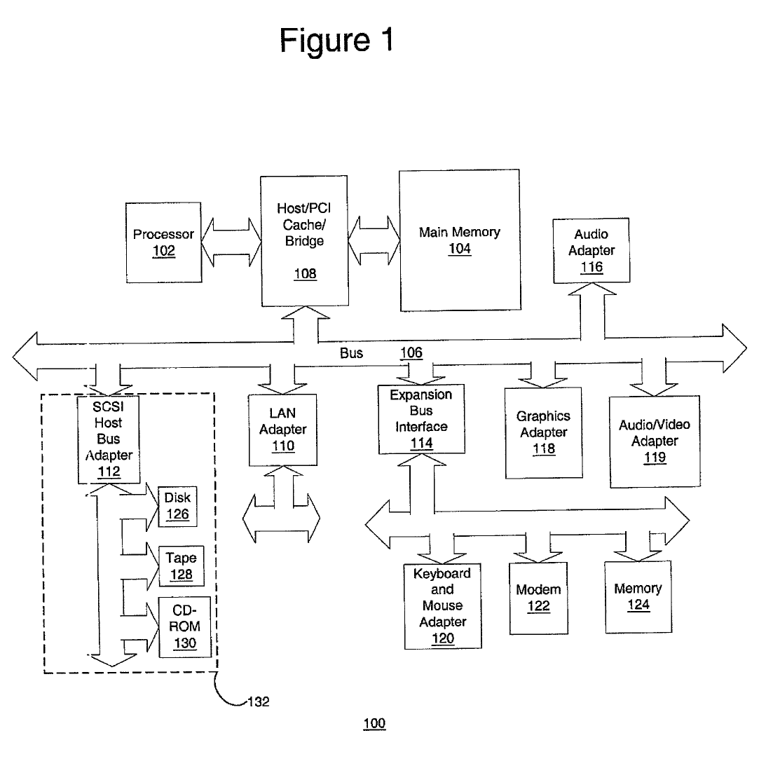

With reference now to the figures and in particular with reference to FIG. 1, a block diagram illustrating a data processing system is depicted in which the present invention may be implemented. Data processing system 100 is an example of a client computer. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system, such as Windows 2000, which is available from Microsoft Corporation. An object oriented programming system such as Java may run in conjunction with the operating system and provide calls to the operating system from Java programs or applications executing on data processing system 100. “Java” is a trademark of Sun Microsystems, Inc. Instructions for the operating system, the object-oriented operating system, and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

As another example, data processing system 100 may be a stand-alone system configured to be bootable without relying on some type of network communication interface, whether or not data processing system 100 comprises some type of network communication interface. As a further example, data processing system 100 may be a Personal Digital Assistant (PDA) device, which is configured with ROM and/or flash ROM in order to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

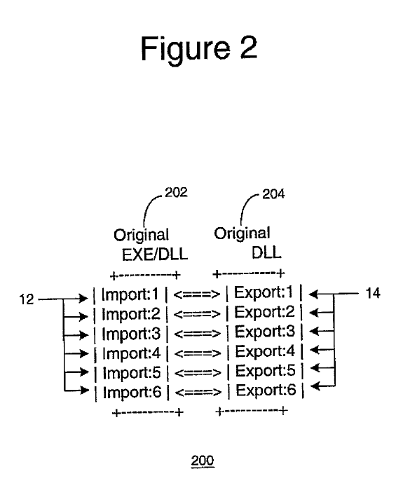

With reference now to FIG. 2, a block diagram illustrating a prior art system for importing modules is depicted. Configuration 200 includes an original importing module 202 (i.e. original executable file or dynamic link library (EXE/DLL)) that references an original exporting module (i.e. dynamic link library (DLL)) 204. A module is an executable entity that may or may not have imports and/or exports. Typical examples of modules include EXE and DLL files as discussed above, but may potentially include SYS, DRV and similar files in some circumstances. The importing module 202 makes the references 12 for importing the specified exports 14 (i.e. exports 1, 2, 3, 4, 5, and 6), and the original exporting module (i.e. the original DLL) 204 has the respective specified exports 14 (i.e. exports 1, 2, 3, 4, 5, and 6) that are referenced by the importing module 202. Thus, the locations of all of the specified exports 14 referenced by the importing module 202 are able to be directly provided to and known by the loader, and the loading of the importing module 202 is able to be completed by the loader.

However, an export can either be an ordinary export of the module (code or data) or a re-export of an import, that is, an explicit forwarder entrypoint which does not refer to anything contained within the module but tells the loader to look for “forward” references to that export elsewhere. Import references to an explicit forwarder entrypoint are resolved by the loader operating as if the import referring to the explicit forwarder entrypoint actually refers to the module and export from which the explicit forwarder entrypoint imports.

The explicit entrypoints are used by the loader to find and determine the location(s) of the specified export so that the loading of the importing module is able to be completed by the loader. An explicit entrypoint is located in the exporting module and may be an explicit forwarder entrypoint that forwards the reference of the specified export to a next exporting module or may export contents of the module. If the location(s) of the specified export(s) is/are found at a particular exporting module(s), then a correlation(s) between the importing module and that particular exporting module(s) is/are made. The “fix up” process of a reference(s) is performed by the loader to resolve all reference(s) to a specified export(s) through explicit entrypoint(s), and resolution for all reference(s) must be resolved before the loader is able to complete the loading of the importing module at load time, or otherwise, the loading of the importing module is unable to be completed by the loader. Thus, any reference(s) made to an explicit entrypoint(s) must be fixed up or resolved during the load time of the importing module.

One of the problems with this method of importing modules occurs if one of the modules or functions within a module that is needed by another module is missing. If a module includes a reference to a module or function that is missing, then the load fails. Thus, even if the missing module may be found in some other location or is not critical to the application, the load fails and the user does not know why.

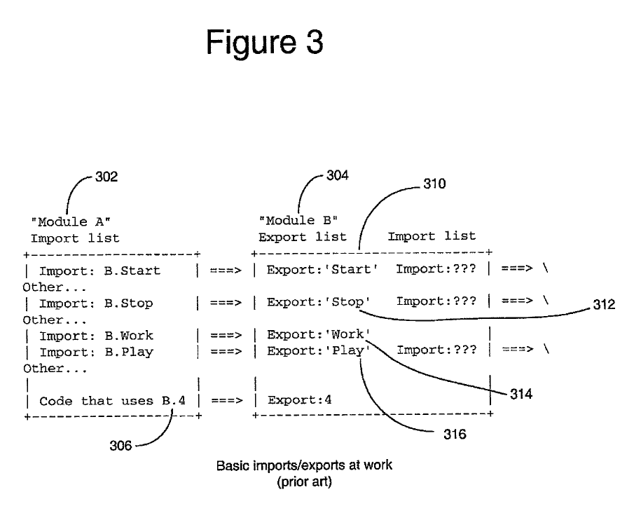

With reference now to FIG. 3, a block diagram illustrating basic imports/exports at work according to the prior art is depicted. Assume that Module A 302 programmatically used the export “B.4” and imports module B's 304 other exports automatically. When it is loaded, the loader locates module B 304, loads it and then looks up “Start” 310, “Stop” 312, “Work” 314 and “Play” 316 from module B 304 to resolve the import requirements of module A 302. When it is run it will query the address of “B.4” and either use the routine or, if it does not exist in this particular version of module B 304, handle the error as best it can which is usually better than the loader does. Also demonstrated is the current technique of “hiding” exported functions by using meaningless “ordinals” (numeric IDs) rather than names for functions that is desired that no one know anything about. This is rudimentary but somewhat effective.

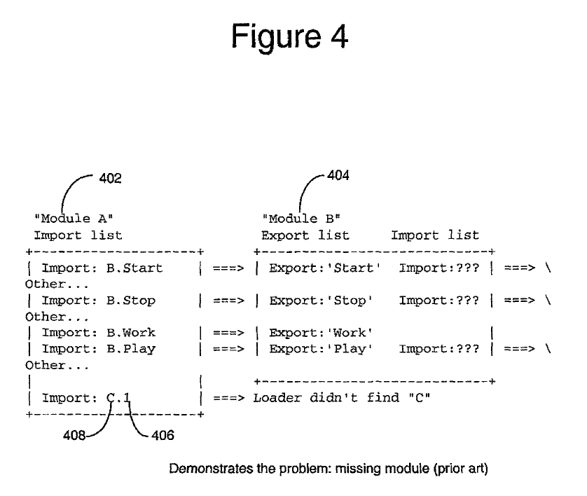

With reference now to FIG. 4, a block diagram of a prior art method of loading an export illustrating a problem when a module is missing is depicted. In the prior art as depicted in FIG. 4, import C.1 408 is automatically imported, rather than programmatically imported. In this case, module A 402 will fail to import “0.1” 406 from the missing module C 408 not found in module B 404 and fail to load. However, if module A 402 had a loader helper function it would have been possible (perhaps) to locate the module and let the loader continue to resolve imports, etc. or, again, at least warn the user gracefully.

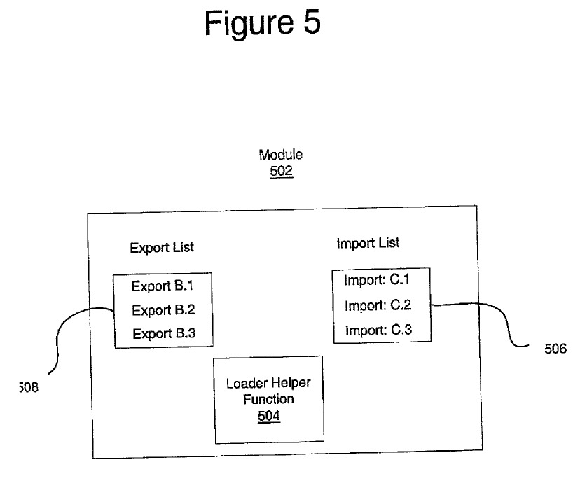

A better system for handling missing modules is to provide loader helper functions within each module or within at least some of the modules used by an application. Thus, with reference now to FIG. 5, a block diagram illustrating a module that includes a loader helper function is depicted in accordance with the present invention. Module 502 may include an import list 506 and an export list 508 similar to export and import lists as described above. In addition, module 502 includes a loader helper function 504 to aid in loading when a module or function is missing.

The loader helper function 504 can be called, as needed by a loader to help resolve modules or exports that it cannot resolve on its own. The loader helper function 504 may then include functionality to perform any of a myriad of tasks. For example, the loader helper function 504 may know that the requested module or function is always found in a certain location such as the dll directory. Alternatively, the loader helper function 504 may access a site on the Internet that it knows contains the needed module and download the module from the internet. The loader helper function 504 may also include functionality to search for the missing module. Many algorithms for searching are available and well known to one of ordinary skill in the art.

If the loader helper function 504 is unable to locate the missing module or function, the loader helper function may simply supply the requesting module with a “dummy” value or function. This “dummy” value or function does not actually perform the functionality of the missing module or function, but allows the application to continue to load. Along with the dummy value or function, the loader helper function 504 may also provide a message to present to the user indicating that certain functionality is missing because a certain module has not been located.

In short, loader helper function 504 is simply a “helper” function defined/exported by the module 502 that can be called by the system/loader whenever it cannot resolve an automatic or programmatic import request. There are a myriad ways to implement this. However, the core features are: 1) a way to locate the helper function, 2) some parameters passed to the function (requesting module, reason, import name/ordinal, security code, etc.), 3) the returned value (error or address and “type” info-16/32/64 bit, code/data, etc.) and 4) enhancements in the loader and programmatic import APIs (DosQueryProcAddr on OS/2) to include calling one or more module's helper functions in the event that the traditional export resolution does resolve the request.

This loader helper function 504 allows an application to make a better effort at locating modules it is dependent on when the loader cannot find them. It also allows an application to report problems to their user instead of failing in silence. It would allow the application/module to alter its behavior rather than fail if an import could not be found. And it would allow the application or module to “provide” missing functionality. (i.e. the app tries to import a “new” API from an old version of the OS where it is missing. Rather than failing to load as we do today, the application/module could provide it's own version of the missing function or fall back to older behavior, but only when it is actually missing.) More subtly, by not exporting anything and filtering all import requests through the loader helper function 504 allows a module 502 to have some secure access control over who has access to which of it's exports 508 or even which callers get which version of its functions.

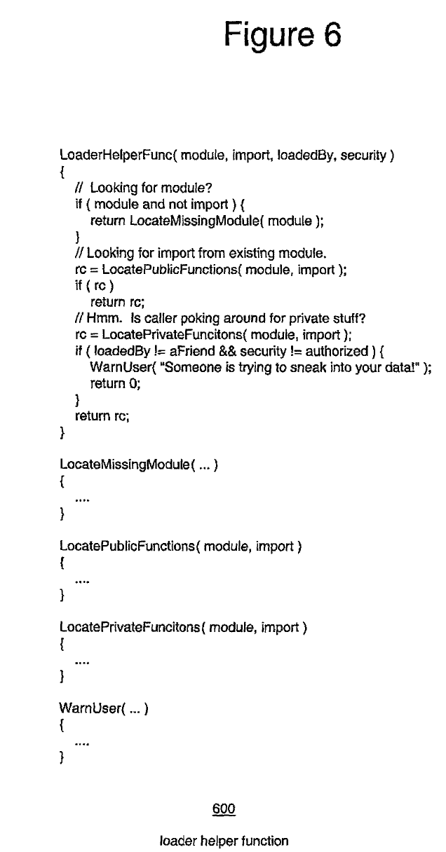

With reference now to FIG. 6, a diagram illustrating an exemplary loader helper function pseudocode is depicted in accordance with the present invention. Given this code 600 attached to modules A 302 and B 304 in the example depicted in FIG. 3 would result in Module B's 304 helper function being called and hopefully resolving module B.4 306. Then, if B.4 remained unresolved, A's 302 helper would be called to resolve, or perhaps report, the missing B.4 306.

In the case depicted in FIG. 4, A's 402 helper function would be called first to try to resolve the location of C.1 406. It is possible that A's 402 helper cannot resolve C.1 406, but can locate module C 408, in which case, module C 408 would be loaded and then the loader would again try to resolve the export C.1 406, first by checking module C's 408 export list. If not found in C's 408 export list, then module C's 408 load helper function (if it has one) is called, and then, if C.1 406 is still not located, module A's 402 loader helper function is called, but this time not to locate the module, but to locate the export.

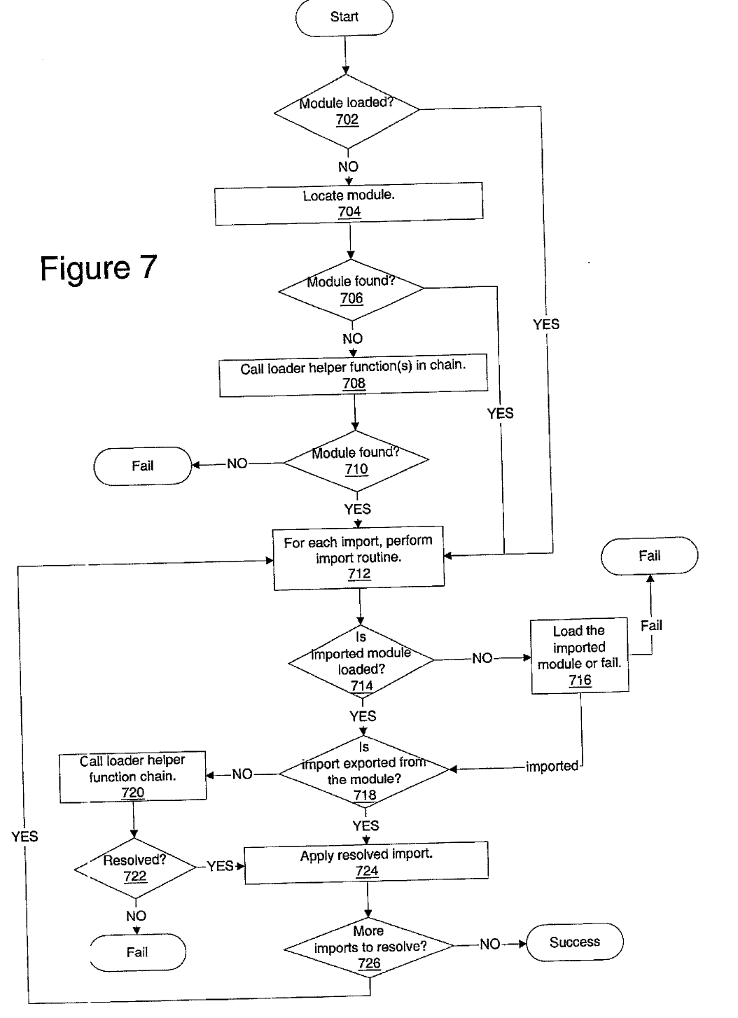

With reference now to FIG. 7, a process flow and program function for use in a loader to provide a loader helper function to help locate and load modules is depicted in accordance with the present invention. To begin, the loader determines if a module has been loaded (step 702). If the module has been loaded, then the loader proceeds to perform the import routine from each import (step 712). If the module has not been loaded, then the loader attempts to locate the module (step 704) and determines whether the module has been found (step 706). If the module has been found, then the loader proceeds to step 712. If the module has not been found, then the loader calls the loader helper function(s) chained together from various modules (step 708) and determines whether the module has been found using the loader helper function (step 710). If the module is not found with the loader helper function(s), then the load routine fails.

If the module is found after calling the loader helper function(s), then the load process proceeds to step 712. For the first import, the loader determines whether the imported module has been loaded (step 714). If the imported module has not been loaded, then the loader attempts to load the imported module (step 716). If the attempt to load the imported module is unsuccessful, then the load routine fails. If the attempt to load the imported module is successful or the imported module has already been loaded, then the loader determines whether the import has been exported from the module (step 718). If the import has been exported from the module, then the export is used to resolve the pending import requirement (step 724). If the import has not been exported from the module, then call the loader helper function(s) chained together from various modules (step 720). After invocation of the loader helper function(s), the loader determines whether the import has been resolved by the load helper function(s) (step 722) and, if not, the load routine fails. If the import is resolved by the loader helper function(s), then the export is used to resolve the pending import requirement (step 724) and then determine whether there are more imports to resolve (step 726). If there are more imports to resolve, the load routine continues with step 712. If there are no more imports to resolve, the load has been successful.

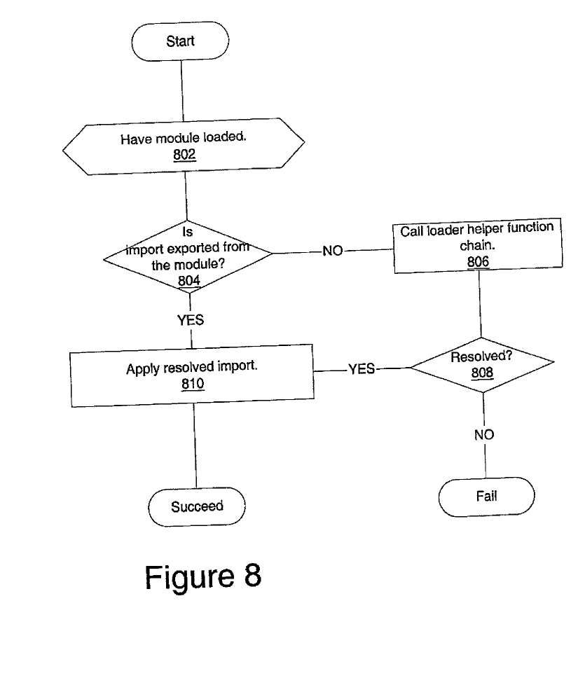

With reference now to FIG. 8, a process flow and program function for import resolution using a loader helper function is depicted in accordance with the present invention. To begin, the module must already be loaded (step 802) such as by using the routine depicted in FIG. 7. Next, the loader determines whether the import has been exported from the module (step 804). If the import has not been exported from the module, then the loader calls the loader helper function chain (step 806) and determines whether the import has been resolved after invoking the loader helper function(s) (step 808). If the import has not been resolved after invoking the loader helper function(s), then the load routine fails. If the import is resolved after invoking the loader helper function chain or if the import is resolved after invoking the loader helper function chain, then apply the resolved import (step 810) thus succeeding at resolving the import.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A module for use with an application program for use in a data processing system, the module comprising:
an export/import list; and
a loader helper function, wherein the loader helper function is callable by a loader to resolve unresolved component.

2. The module as recited in claim 1, wherein the export/import list includes at least one of an imported function and an exported function.

3. The module as recited in claim 1, wherein the unresolved component is an unresolved module.

4. The module as recited in claim 1, wherein the unresolved component is an unresolved export.

5. A method for resolving an unresolved module required by a loader in loading an application, the method comprising:
determining that a component is unresolvable by the loader;
calling a loader helper function to resolve the component; and
responsive to the loader helper function resolving the component, using the component to resolve a pending import requirement.

6. The method as recited in claim 5, wherein loading the module comprises:
responsive to a determination that the component is unresolvable by the loader helper function, calling a loader helper function in another module to aid in resolving the component.

7. The method as recited in claim 6, further comprising:
responsive to the loader helper function in another module resolving the component, using the component to resolve a pending import requirement.

8. The method as recited in claim 5, wherein the component is a module.

9. The method as recited in claim 5, wherein the component is an export.

10. A computer program product in a computer readable media for use in a data processing system for resolving an unresolved module required by a loader in loading an application, the computer program product comprising:
first instructions for determining that a component is unresolvable by the loader;
second instructions for calling a loader helper function to resolve the component; and
third instructions, responsive to the loader helper function resolving the component, for using the component to resolve a pending import requirement.

11. The computer program product as recited in claim 10, wherein loading the module comprises:
fourth instructions, responsive to a determination that the component is unresolvable by the loader helper function, for calling a loader helper function in another module to aid in resolving the component.

12. The computer program product as recited in claim 11, further comprising:
fifth instructions, responsive to the loader helper function in another module resolving the component, for using the component to resolve a pending import requirement.

13. The computer program product as recited in claim 10, wherein the component is a module.

14. The computer program product as recited in claim 10, wherein the component is an export.

15. A system for resolving an unresolved module required by a loader in loading an application, the system comprising:
a resolving unit which determines that a component is unresolvable by the loader;
a loader helper caller which calls a loader helper function to resolve the component; and
an import unit which, responsive to the loader helper function resolving the component, uses the component to resolve a pending import requirement.

16. The system as recited in claim 15, wherein the import unit comprises:
a load chain caller which, responsive to a determination that the component is unresolvable by the loader helper function, calls a loader helper function in another module to aid in resolving the component.

17. The system as recited in claim 16, wherein the import unit, responsive to the loader helper function in another module resolving the component, uses the component to resolve a pending import requirement.

18. The system as recited in claim 15, wherein the component is a module.

19. The system as recited in claim 15, wherein the component is an export.
